(19) United States
(12) Patent Application Publication
(10) Pub. No.: US 2004/0217838 A1
(43) Pub. Date: Nov. 4, 2004

(54) Coil device

(76) Inventor: Guy J. Lestician, East Stroudsburg, PA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 10/834,778

(22) Filed: Apr. 29, 2004

Related U.S. Application Data
(60) Provisional application No. 60/466,315, filed on Apr. 29, 2003.

(51) Int. Cl. H01F 27/30

(52) U.S. Cl. 336/198

(57) ABSTRACT

A coil device includes a primary winding of multistranded wire that has been wound around a supporting structure, a conductive core positioned both inside and outside the primary winding, a first insulating layer around the primary winding, and at least one securing member that secures the core, supporting structure and primary winding as a coil device unit. The device may also include a secondary winding of wire, such as multistranded wire. The device may be used as a self-adjusting transformer or choke in electrical applications.

### RELATED APPLICATIONS

This application claims priority to, and incorporates by reference, U.S. provisional patent application No. 60/466,315, filed Apr. 29, 2003.

### TECHNICAL FIELD

This application relates to improvements in coil devices for use in transformer, reactor and/or choke applications, along with methods for manufacturing such devices.

### BACKGROUND

Wound coil products, such as choke coils, transformer coils and reactors, have existed for many years. Examples of such products and methods for their manufacture are disclosed in, for example, U.S. Pat. No. 6,531,946, to Abe et al.; U.S. Pat. No. 6,144,279, to Collins et al.; U.S. Pat. No. 5,521,467, to Statnic et al.; U.S. Pat. No. 5,315,279, to Ito et al.; U.S. Pat. No. 5,210,930, to Watabe et al.; and U.S. Pat. No. 4,587,507, to Takayama et al., each of which is incorporated herein by reference in its entirety.

Prior wound coils do not always exhibit desired features of being small in size, being able to filter harmonic distortions, achieving higher power output, and not becoming overly hot during operation. Accordingly, it is desirable to provide an improved wound coil and method for its manufacture as described herein.

### SUMMARY

In accordance with a first embodiment, a coil device includes a primary winding of multistranded wire that has been wound around a supporting structure, a conductive core positioned both inside and outside the primary winding, a first insulating layer around the primary winding, and at least one securing member that secures the core, supporting structure and primary winding as a coil device unit. Optionally, the device may include a secondary winding of wire. The secondary wire may optionally be multistranded, and it may be positioned around the primary winding and/or the first insulating layer. A second insulating layer may be positioned around the secondary winding. Optionally, the conductive core includes members positioned both inside and outside of the primary winding, and the members positioned inside the primary winding provide an air gap. The primary winding and/or the secondary winding may have been wound in a counterclockwise direction.

In accordance with an alternate embodiment, a method of manufacturing a coil device includes winding a multistranded wire around a supporting member to substantially fill the supporting member in a substantially even manner, inserting conductive cores into the supporting member and leaving an air gap between the conductive cores, applying an insulating layer around the wire, and securing the cores to provide a coil device. Optionally, the method may also include applying an insulating layer to the wire at an entry point and/or an exit point of the supporting member. Also optionally, the winding step may be performed in a counterclockwise direction. The method may also include applying a secondary winding of wire around the supporting member.

### BRIEF DESCRIPTION OF THE DRAWINGS

FIG. 1 is a top plan view of an embodiment of the present inventive device;

FIG. 2 is a side view of an embodiment of the present inventive device;

FIG. 3 is a top plan view of an exemplary bobbin that may be used in the development of an embodiment of the inventive device according to an embodiment of the method;

FIGS. 4A-4C provide side, top plan and bottom plan views of an exemplary locking clip.

FIG. 5 is a flowchart that shows the steps that may be performed in an embodiment of the method of preparing a coil device.

FIG. 6A is a printout showing an exemplary input signal for an improved inventive coil, while FIG. 6B is a printout showing an exemplary output signal.

### DETAILED DESCRIPTION

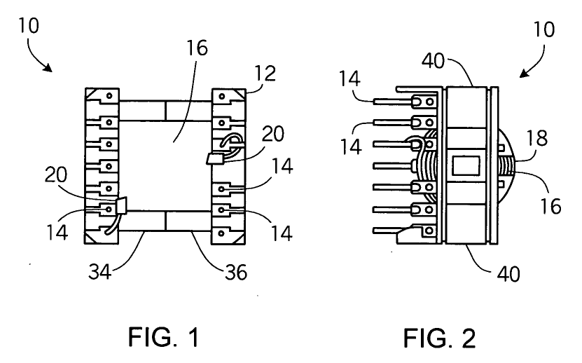

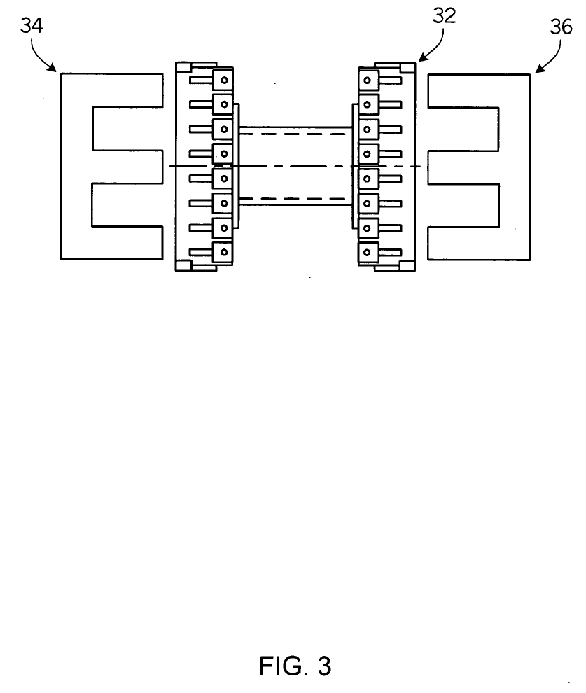

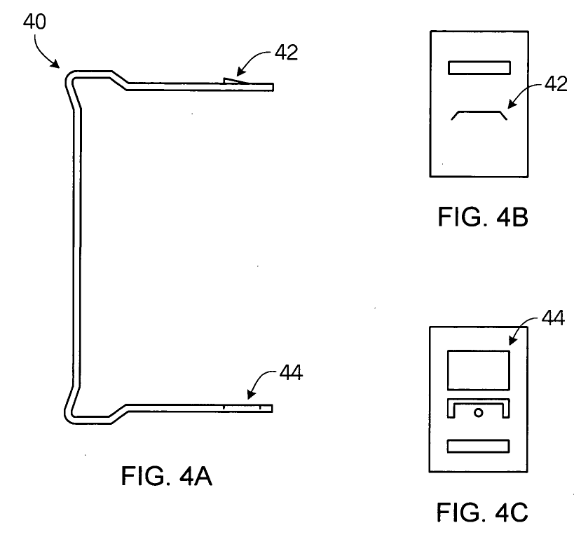

FIGS. 1 and 2 illustrate a top plan view and a side view, respectively, of an embodiment of the present inventive coil device 10. Referring to FIG. 1, a bobbin 12, typically made of a plastic or metal material, although other materials are possible, may be used as the base structure around which the coil 16 is wound. Although not required, in an embodiment the bobbin 12 includes a plurality of conductive pins 14, which may be made of metal or another conductive material and which may be inserted, for example, into a circuit board when used in a circuit. FIGS. 1 and 2 illustrate an embodiment where each bobbin 12 has thirteen pins. However, other embodiments may use more or fewer pins. An example of a bobbin 32 having sixteen pins is shown in FIG. 3. The size of the bobbin may vary in accordance with the invention. Such bobbins may include common commercially-available bobbins, including but not limited to those with common part numbers such as PQ-34, ETD-34, ETD-29, ETD-39 and others, depending on the size of the coil device desired.

Returning to FIGS. 1 and 2, a coil 16 is wound around the center section of the bobbin 12. The coil 16 is made of a multistranded wire, such as that commonly known as litz wire, in which each wire is constructed of individual film insulated wires bunched or braided together in a substantially uniform pattern of twists. The multistranded construction may result in a higher power output than that which may be encountered in a solid conductor. In a preferred embodiment, multiple strands of litz wire are wound around the bobbin in an evenly distributed manner.

The number and the length of the strands, used will vary depending on the wire gage used, the hardness of the conductive core (described below) that is used, the air gap size in the conductive core, and/or the desired power output and/or inductance. For example, the exemplary number of strands and size of wire for the embodiment shown in FIGS. 1 and 2 is two wires (i.e., twenty individual strands, where each litz wire contains ten individual strands) of litz wire such as 30-gage litz wire, and the exemplary wire used in the embodiment shown in FIG. 3 is four wires (i.e., forty strands) of litz wire such as 30-gage litz wire. The preferred length of strand for a coil made with ETD-39 bobbin (as illustrated in FIG. 3) is about eleven feet long (i.e., about 48 turns around the bobbin), although other lengths may be used for this and other bobbins. As another example, an ETD-34 or PQ-34 bobbin may use an approximately 8-foot length of #30, 20-stranded litz wire. The length of wire used will vary, but it should be sufficient to allow the wire to substantially fill the bobbin when the bobbin is turned.

During winding, in an embodiment of making the coil device the wires are maintained slightly taut to allow even distribution, but the wires are not pulled so tightly that the dielectric in the wires breaks down. In addition, the combination of multiple strands within the wires, along with the winding in a slightly taut manner, provides air gaps that help to keep the device cool when a voltage is applied. Although not required, the winding may be done by turning the bobbin in a counterclockwise direction. As used herein, a “counterclockwise direction” means the direction viewed when observing the turn of the bobbin from the side opposite that to which the wire is attached as a starting point. This may also be known as “top coming” to those skilled in the art. Surprisingly, I have found that a counterclockwise winding technique reduces the ridge that builds up in the winding near the starting point, and thus it reduces the resulting coil's susceptibility to arcing. I have also found that the centers of some bobbins may have ridges, and that it may therefore be desirable to apply one or more layers of tape to the center before winding in order to even out the winding surface.

Each strand of wire in the coil may be electrically connected to a pin 14 on one side of the bobbin 12 as well as to a pin 14 on the other side of the bobbin, such that the starting point is on one side and the end point is on another side of the bobbin. The specific pins used as starting points and ending points may vary. Since litz wire strands are typically grouped, such as in groups of ten strands, all strands may be attached to a single pin on each side of the bobbin, or optionally the groups may be attached to one or more different pins. The electrical connections are preferably made by soldering or another conductive connecting means. An insulating material 20 such as electrical tape or an insulating sheath is preferably applied around the wire where it meets the pins in order to insulate the wire from the pins other than the pin to which electrical connection is desired. The insulating material 20 also prevents the coil from shorting when a voltage is applied to the coil.

When the coil is made and the pins are connected to the coil wire, an insulating and/or securing layer 18, such as electrical tape and/or a varnish, may be applied to the outside of the coil in order to secure the coil and/or provide additional insulation. This may be done, for example, by dipping the coil in hot (e.g., approximately 180° F.) varnish and then allowing it to air dry. In an embodiment, an insulating layer of tape may be applied and then covered with varnish. Although not required, insulating/securing layer 18 is preferred.

After the coil is completed, a conductive core material is inserted into the bobbin. Referring to FIG. 3, in an embodiment two E-shaped core members 34 and 36 are inserted into the bobbin to provide a magnetic core. The core members are preferably made of ferrite, polybutyleneterephtalate or other metal materials or alloys, such as those disclosed in U.S. Pat. No. 6,144,279. In addition, the core members may have other shapes, such as rounded “E's” or other shapes that are appropriate for the bobbin. Referring to FIG. 1, when inserted into the bobbin 12, the core members 34 and 36 may meet at a gap 38. If the size of the gap 38 is increased, the resulting inductance can be increased and power output can be decreased. Conversely, if the gap 38 is small, or if core members 34 and 36 touch, inductance is decreased and power output is increased. Thus, the size of the gap may vary depending on the desired characteristics of the coil device.

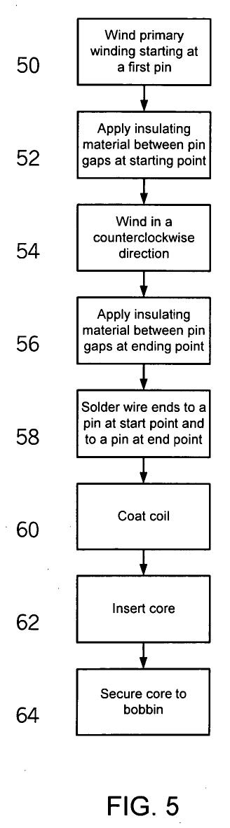

After the core members have been inserted into the bobbin, a means to secure the device together may be attached to the device. An example of such a securing means is illustrated in FIG. 2 and FIGS. 4A through 4C. Referring to FIGS. 4A through 4C, in this example a locking clip 40 includes a first arm having a tab 42 and a second arm having a receptacle 44. Referring to FIG. 2, two locking clips made of metal or other relatively firm material are inserted around the core members such that the tab of each locking member engages the receptacle of the other locking member. The exemplary locking clip may be made of steel or another relatively firm material. Of course, other appropriate securing means, such as fasteners, grips, or even tape, may be used.

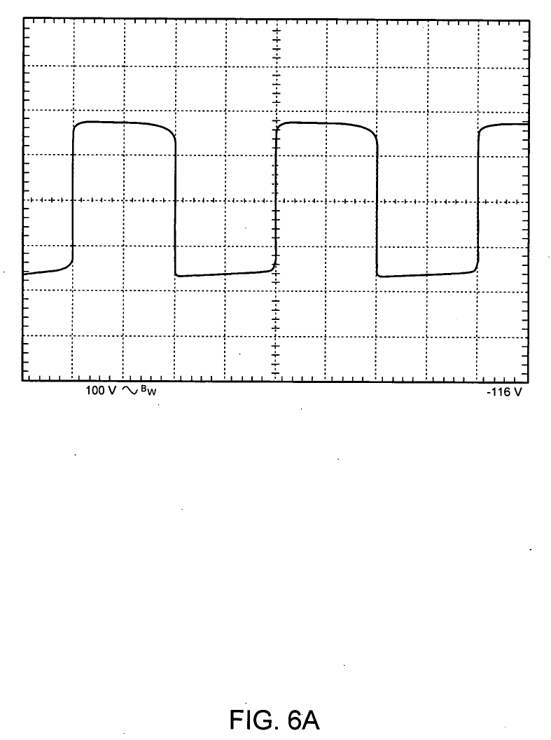

FIG. 5 is a flowchart that shows exemplary steps in a method of preparing a coil device. Referring to FIG. 5, a group of multistranded wire strands are wound to a bobbin, starting at a first pin on the bobbin (step 52). An insulating material such as electrical tape may be placed over the wire at the starting point near the pins (step 54), either before or after the winding is performed. Optionally, a layer of tape may also be applied to the center of the bobbin before winding in order to smooth any ridges. The wire is then wound around the bobbin, optionally in a counterclockwise direction, optionally using a winding device such as a Bobbineer™, in an evenly distributed manner. The wires are not held too tightly during winding so that the wires are not damaged during winding and so that small air gaps are provided in the final coil. An insulating material may also be applied to the wires at the end point (step 56), and the wire ends at each end point may be soldered or otherwise electrically connected to the pins of the bobbin (step 58).

In embodiments where the coil device is not intended for use in a circuit board application, the bobbin may not need to include pins, and thus the wire ends may merely be soldered or otherwise connected so act as a single conductive strand. In addition, the insulating material may not be required if pins are not used.

Optionally, a secondary winding may be applied on top of the first winding be repeating the process described above. The second winding is typically smaller than the primary winding, and it may be separated from the primary winding by tape or another insulating layer. Optionally, the secondary winding may also be made of multistranded wire. Optionally, the secondary winding may also be partially or fully covered by a second insulating layer.

When the winding is complete, the coil may be coated (step 60) with a material such as tape or varnish to secure the coil and/or provide insulation.

The conductive core is then inserted into the bobbin (step 62). If pins are not used, the bobbin may optionally be removed after winding, and the core material may simply be placed directly into the core of the coil. An air gap may be left in between the two halves of the conductive core, and the gap can vary depending on the desired characteristics of the device.

The device may then be secured (step 64) by an appropriate fastener, tape or other material or mechanism.

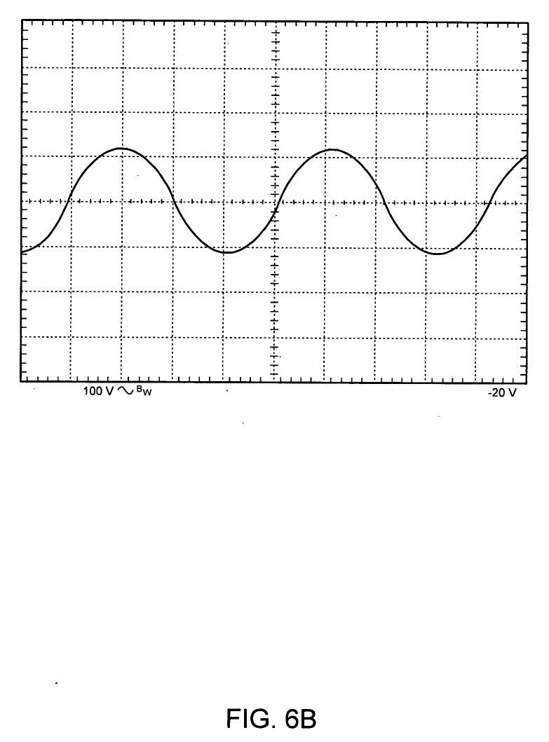

Surprisingly and advantageously, I have found that this construction and method of winding produces a coil device that has improved filtering characteristics, and which in preferred embodiments can transform a distorted signal or a DC or pulsed input signal, such as that illustrated in FIG. 6A, into a substantially sinusoidal signal such as that illustrated in FIG. 6B. The use of multistranded or litz wire also provides improved response times, such as when the coil device is used in connection with a ballast or other circuit for lighting a lamp, including but not limited to ballasts and circuits such as those disclosed in U.S. Pat. No. 6,344,717, to Lestician; U.S. Pat. No. 5,521,467, to Statnic et al.; U.S. Pat. No. 5,323,090, to Lestician; and U.S. Pat. No. 5,287,040, to Lestician. Further, I have surprisingly found that use of multistranded litz wire can increase the power output of the device while reducing the current draw as compared to a coil that has been wound in a clockwise direction and/or using conventional wire. It also may allow the device to operate in a manner that is cooler than ordinary chokes or transformers using solid wire. Although secondary windings may also be provided to allow use of the device as a transformer, secondary windings are not required when the present coil device is used as a choke.

Thus, the coil device can be used as an input or output transformer or a choke in the power circuit for a bulb, lamp, motor or other load. The device may self-adjust to match the inductance of the load, without the need for physically re-winding the coil. For example, embodiments described above can be used in a ballast to control and power a 150-watt bulb as well as a 400-watt bulb. In examples, in one embodiment the coil device was used in connection with a ballast controller to light a lamp, and it was found that the device automatically adjusted to a 1-amp current flow for a 150-watt bulb and a 3.4-amp current flow for a 400-watt bulb. Also, when used in a lighting controller the coil device may automatically adjust to the status of the bulb. For example, when a bulb is cool, it may have a low inductance (such as 400 microhenrys), but when it is hot the inductance decrease (such as to approximately 30 microhenrys), and the coil device can be used for such applications. Further, when used in a lighting controller I have found that the coil device can be separated from the bulb by a wire distance of as much as 200 feet or more without any significant loss of output.

An alternate embodiment of the invention may use a toroidal conductive core, and multistranded or litz wire may be wound around the toroidal core in a counterclockwise direction by hand or by using a mechanical winding device. In embodiments, I have found that the use of multistranded wire may reduce the current draw for a load by, for example, as much as 50% or more as compared to solid wire. Thus, heat loss may also be reduced. The toroidal core may be equipped with pins for mounting in a circuit board.

The following examples illustrate various embodiments of the present invention. These are not the only possible embodiments, and are presented for illustration only:

### EXAMPLE 1

A bobbin having part no. ETD-34 or PQ-34 serves as the basis for winding a coil device. Approximately eight feet of no. 30 litz wire, having 20 strands, in which two groups of ten strands each are available, are used to wind a primary winding starting at pin number 3 on the bobbin. A small amount of insulating tape is applied to the wire in the gap between the bobbin's number 3 and number 4 pins. The wires are wound around the center piece of the bobbin in a counterclockwise direction until the bobbin is substantially filled, just shy of the sides of cores when inserted. Two layers of Mylar tape are applied to the wound wires, and the wires are positioned to exit the bobbin at pin 11. The starting point wires are soldered to pin 3 and the exit point wires are soldered to pin 11 or 14. Two ferrite cores, such as those having part number ETD-34, are inserted into the bobbin with a central air gap of approximately 0.01 inch. The resulting coil device is dipped in varnish, such as type UL108 varnish, at a temperature of approximately 180° F. until dry. The resulting coil device has an inductance of approximately 1.0 mH, although the actual inductance may vary by plus/minus 10 percent embodiments in some embodiments, and in other embodiments it may vary by as much as plus/minus 50 percent. The device may be used to use as a choke in connection with the circuit of, for example, a 150 watt bulb.

### EXAMPLE 2

A bobbin having part no. ETD-39 is used to wind approximately 12 feet of number 30 litz wire having four groups of ten strands each. If the bobbin has ridges on its central core, one or two layers of insulating tape are applied around the central core to provide an even core area. A small amount of insulating tape is applied to the wire over the gap between bobbin starting pins 13 and 14. The wires are then wound around the center member of the bobbin in a clockwise direction and exit the bobbin at pin 3, with an insulating layer placed around the wire at the exit point. Two groups of strands of wire are soldered to pins 4 and 5 near the exit point, while two groups of wire are soldered to pins 13 and 14 at the starting point. Ferrite cores having part no. ETD39PM60-385 are inserted with an air gap of approximately 0.03 inch left between the cores. One or two layers of Mylar tape are applied to the coil and the coil is varnish dipped at approximately 180° F. and allowed to air dry. The resulting device has an inductance of approximately 315.5 mH, with a variability of plus/minus 10 percent, or even plus/minus 50 percent. The unit may be used, for example, to power a 400 watt bulb. Optionally, before the unit is varnished dipped, a secondary winding may have also been applied to the device.

The invention is not limited in its application to the details of construction and to the arrangements of the components disclosed herein or illustrated in the drawings. The invention is capable of other embodiments and of being practiced and carried out in various ways. Also, it is to be understood that the phraseology and terminology employed herein is used for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

The invention claimed is:

1. A coil device, comprising:
a primary winding of multistranded wire around a supporting structure;
a conductive core positioned both inside and outside the primary winding;
a first insulating layer around the primary winding; and
at least one securing member that secures the core, supporting structure and primary winding as a coil device unit.

2. The coil device of claim 1, further comprising a secondary winding of multistranded wire around the first insulating layer and a second insulating layer around the first insulating layer.

3. The coil device of claim 2, further comprising a second insulating layer around the secondary winding.

4. The coil device of claim 1, wherein the insulating layer comprises insulating tape.

5. The coil device of claim 1, wherein the insulating layer comprises a varnish.

6. The coil device of claim 1, wherein the supporting structure comprises a bobbin.

7. The coil device of claim 1, wherein the conductive core comprises two ferrite members.

8. The coil device of claim 7, wherein the two ferrite members are substantially “E” shaped and are positioned to provide an air gap between at least one center element of the ferrite members.

9. The coil device of claim 1, wherein the primary winding has been wound around the supporting structure in a counterclockwise direction.

10. The coil device of claim 1, further comprising an insulating layer positioned between the supporting structure and the primary winding.

11. A method of manufacturing a coil device comprising:
winding a multistranded wire around a supporting member to substantially fill the supporting member in a substantially even manner;
inserting conductive cores into the supporting member and leaving an air gap between the conductive cores;
applying an insulating layer around the wire; and
securing the cores to provide a coil device.

12. The method of claim 11 wherein the step of applying an insulating layer comprises applying tape.

13. The method of claim 11 wherein the step of applying insulating layer comprises applying a varnish.

14. The method of claim 11 further comprising applying an insulating layer to the wire at an entry point and/or an exit point of the supporting member.

15. The method of claim 11 wherein the winding step is performed in a counterclockwise direction.

16. The method of claim 11 further comprising applying a secondary winding of wire around the supporting member.

17. A coil device, comprising:
a primary winding of multistranded wire;
a conductive core having at least one member positioned inside the primary winding and at least one member positioned outside the primary winding, wherein the at least one member positioned inside the primary winding includes an air gap;
an insulating layer around the primary winding; and
at least one securing member that secures the core, supporting structure and primary winding as a coil device unit.

18. The coil device of claim 17, further comprising a secondary winding of multistranded wire.

19. The coil device of claim 18, wherein the secondary winding is around the first insulating layer.

20. The coil device of claim 18, wherein the secondary winding is around the first insulating layer.
